(19) United States
(12) Patent Application Publication
(10) Pub. No.: US 2003/0170549 A1
(43) Pub. Date: Sep. 11, 2003

(54) Non-aqueous electrolyte battery

(75) Inventor: Tetsuya Murai, Kyoto-shi (JP)

Correspondence Address: SUGHRUE MION, PLLC, 2100 PENNSYLVANIA AVENUE, N.W., WASHINGTON, DC, 20037, US

(73) Assignee: JAPAN STORAGE BATTERY CO., LTD.

(21) Appl. No.: 10/347,735

(22) Filed: Jan. 22, 2003

(30) Foreign Application Priority Data
Feb. 1, 2002 (JP) P.2002-025969

(51) Int. Cl. H01M 10/40

(52) U.S. Cl. 429/329; 429/332; 429/340; 429/342; 429/200

(57) ABSTRACT

A non-aqueous electrolyte battery of the invention comprises a non-aqueous electrolyte which contains a chain carbonic ester having a hydrocarbon group with carbon number varied from 4 to 12 and a hydrocarbon group with carbon number varied from 1 to 12, a non-aqueous solvent and a lithium salt; wherein the non-aqueous solvent contains ethylene carbonate, propylene carbonate or gamma-butyrolactone, and the sum of volume ratios of ethylene carbonate, propylene carbonate and gamma-butyrolactone in the non-aqueous solvent is 80% or more.

### FIELD OF THE INVENTION

This invention relates to a non-aqueous electrolyte battery.

### BACKGROUND OF THE INVENTION

With the recent rapid development of technology in the field of electronics, electronic appliances such as cellular phones, notebook computers and video cameras have increasingly become sophisticated as well as being reduced in size and weight, and accordingly the demands for the batteries with a high energy density which can be used for these appliances are significantly growing. Among the most commonly used batteries satisfying the foregoing demands is a non-aqueous electrolyte secondary battery in which carbon materials and the like, which are capable of absorbing/releasing lithium or lithium ion, are used as a negative active material.

A non-aqueous electrolyte secondary battery comprises, for example, a negative electrode comprising a lithium ion absorbing/releasing carbon material applied on a current collector; a positive electrode comprising a lithium ion absorbing/releasing lithium composite oxide, such as lithium-cobalt composite oxide, applied on a current collector; and an electrolyte solution comprising an aprotic organic solvent having a lithium salt, such as LiClO₄, LiPF₆, etc., dissolved therein; as well as a separator lying between the negative electrode and the positive electrode to prevent a short circuit from occurring. These negative and positive electrodes are formed into thin sheets or foils and overlapped or spirally wound with the separator therebetween to constitute a spirally coiled electrode block, which is housed into a metal can made of stainless- or nickel-plated steel or lighter metal such as aluminum and the like, or a battery case made of laminate film. Then, the electrolyte solution is poured into the can or case, and after the sealing is done, the battery making process is completed.

Generally, various performances are required for batteries depending on how they are used, and among them is a high temperature storage characteristic, which plays an important role in the above mentioned secondary batteries. It is usually evaluated by the measurement of the bulging or discharge capacity of a charged battery which was left for a certain time at a temperature of over 80° C.

There are a variety of approaches to improving a high temperature storage characteristic. An approach commonly applied to the above mentioned non-aqueous electrolyte secondary batteries is to use a high-boiling-point, low-vapor-pressure organic solvent. In Japanese Patent Applications No. 2002-42865, 2002-235868 and H11-11306, processes involving the incorporation of ethylene carbonate, gamma-butyrolactone and propylene carbonate, as a main solvent, having a high boiling point and a high induction rate were proposed.

However, the incorporation of such components as gamma-butyrolactone or propylene carbonate having a high-boiling-point and a low-vapor-pressure, as a main solvent, was disadvantageous in that the surface tension of a non-aqueous solvent increased, wettability of non-aqueous electrolyte on electrodes and a separator became insufficient, and then permeability of electrolyte solution in the separator or the electrodes was remarkably deteriorated.

Thus, when the permeability of an electrolyte solution in the separator was insufficient, discharge characteristic at high rate became less efficient because the facing area of the electrodes was reduced by a portion of area not permeated by the electrolyte solution.

Furthermore, there arose the problems that metalic lithium was deposited on the negative electrode because charge current was concentrated on the facing portion where the electrolyte solution had permeated and, accordingly, this could cause a short circuit or deteriorate discharge performance.

### SUMMARY OF THE INVENTION

It is an object of the present invention to provide a non-aqueous electrolyte secondary battery which comprises excellent charge and discharge performance and a small bulge at high temperature storage even in the case where the above mentioned non-aqueous solvent having a high-boiling-point and large surface tension is used. The object is accomplished by improving the wettability of a non-aqueous electrolyte in electrodes and a separator.

The non-aqueous electrolyte secondary battery of the invention comprises a non-aqueous electrolyte which comprises a chain carbonic ester represented by formula 1, wherein R1 is a hydrocarbon group with carbon number varied from 4 to 12, and R2 is a hydrocarbon group with carbon number varied from 1 to 12; a non-aqueous solvent except said chain carbonic ester, wherein said non-aqueous solvent contains ethylene carbonate, propylene carbonate or gamma-butyrolactone, and the sum of volume ratios of ethylene carbonate, propylene carbonate and gamma-butyrolactone in said non-aqueous solvent is 80% or more; and a lithium salt.

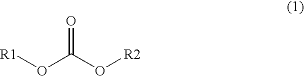

According to the invention, as a main solvent for an electrolyte solution, which has a high-boiling-point, low-vapor-pressure solvent such as ethylene carbonate, propylene carbonate or gamma-butyrolactone, or a mixture of at least one or two of them improves a storage characteristic at high temperature. In addition, the incorporation of a chain carbonic ester represented by formula 1 can improve wettability of a non-aqueous electrolyte on electrodes or a separator. So the battery shows excellent charge and discharge performance, and minor bulging even at high temperature storage.

### BRIEF DESCRIPTION OF THE DRAWINGS

FIG. 1 is a longitudinal sectional view of the prismatic non-aqueous electrolyte secondary battery according to the invention.

### DESCRIPTION OF THE PREFERRED EMBODIMENT

The non-aqueous electrolyte secondary battery of the invention comprises a non-aqueous electrolyte battery which contains a chain carbonic ester represented by formula 1, wherein R1 is a hydrocarbon group with carbon number varied from 4 to 12, and R2 is a hydrocarbon group with carbon number varied from 1 to 12; a non-aqueous solvent except said chain carbonic ester, wherein said non-aqueous solvent contains ethylene carbonate, propylene carbonate or gamma-butyrolactone, and the sum of volume ratios of ethylene carbonate, propylene carbonate and gamma-butyrolactone in said non-aqueous solvent is 80% or more; and a lithium salt.

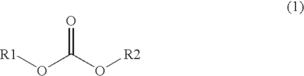

In the present invention, it is not necessary for a non-aqueous solvent to contain all of these three solvents; ethylene carbonate, propylene carbonate and gamma-butyrolactone. Only one solvent or the incorporation of two of these solvents is allowable.

According to the invention, as a main solvent for an electrolyte solution, which has a high-boiling-point, low-vapor-pressure solvent such as ethylene carbonate, propylene carbonate or gamma-butyrolactone, or a mixture of at least one or two of them improves a storage characteristic at high temperature and, in addition, the incorporation of a chain carbonic ester represented by formula 1 can provide improve wettability of a non-aqueous electrolyte in electrodes or a separator. So the battery shows excellent charge and discharge performance, and minor bulging even at high temperature storage.

In the non-aqueous electrolyte secondary battery according to the invention, it is preferable that said non-aqueous solvent contains at least either propylene carbonate or gamma-butyrolactone at a concentration of 50 vol % or more, more preferably 80 vol % or more.

This allows the melting point of non-aqueous electrolyte to be lowered. So the discharge performance at high temperature of the battery will improve.

In the non-aqueous electrolyte secondary battery according to the invention, it is preferable that the weight ratio of said chain carbonic ester represented by formula 1 to the sum of said non-aqueous solvent and said lithium salt in said non-aqueous electrolyte is not less than 0.5% and not more than 5%.

When the weight ratio exceeds 0.5%, the wettability of non-aqueous electrolyte in the electrodes or the separator further improves, and when the weight ratio falls below 5.0%, the battery exhibits excellent discharge performance at low-temperature/high-rate.

The reason that the discharge performance at low-temperature/high-rate of a battery is deteriorated when the weight ratio of the chain carbonic ester represented by formula 1 to the sum of said non-aqueous solvent and said lithium salt exceeds 5.0% is probably because the viscosity of the electrolyte solution becomes high and, moreover, high resistance surface-electrolyte-interface (SEI) film is formed on the negative electrode.

In the non-aqueous electrolyte secondary battery according to the invention, it is preferable that said chain carbonic ester represented by formula 1 contains di-normal-butyl carbonate, methylhexyl carbonate or methyloctyl carbonate.

This allows a battery to have excellent discharge performance at low temperature.

In the non-aqueous electrolyte secondary battery according to the invention, it is preferable that said non-aqueous solvent contains vinylene carbonate, vinylethylene carbonate, 1,3-propane sultone, 1,3-propene sultone(propane-1-ene-1,3-sultone), ethylene glycol cyclic sulfate or divinyl sulfone.

The addition of these compounds inhibits the formation of surface film on the negative electrode due to the reduction decomposition of the chain carbonic ester represented by formula 1 and has an effect on reducing the resistance of surface film on the negative electrode, so that it is possible to obtain a battery having a great initial discharge capacity and excellent discharge performance at low temperature.

In the non-aqueous electrolyte secondary battery according to the invention, it is preferable that part or all of the hydrogen of said R1 or said R2 is substituted by halogen.

The substitution of part or all of the hydrogen of said R1 or said R2 by halogen provides excellent discharge performance at low temperature.

In the non-aqueous electrolyte secondary battery according to the invention, it is preferable that the volume ratio of ethylene carbonate in said non-aqueous solvent is not less than 0.1% and not more than 50%.

When the volume ratio of ethylene carbonate in the solvent exceeds 0.1%, surface film on a negative electrode is formed due to the reduction decomposition of ethylene carbonate at the first charge and discharge and the formation of the film inhibits the subsequent decomposition of the solvent, so that the first charge and discharge efficiency can be improved and accordingly an initial discharge capacity of a battery will increase.

In addition, when the volume ratio of ethylene carbonate exceeds 50%, since ethylene carbonate has a higher melting point than propylene carbonate or gamma butyrolactone, the viscosity of the electrolyte solution at low temperatures increases and the ion conductivity of the electrolyte decreases, so that there arises a problem that the discharge performance at low temperature is deteriorated.

### EXAMPLES

In the following paragraphs, specific examples of the present invention will be described in detail. These examples are clearly meant to be non-limiting, and therefore it is possible to make various changes and modifications without departing from the spirit and scope of the invention.

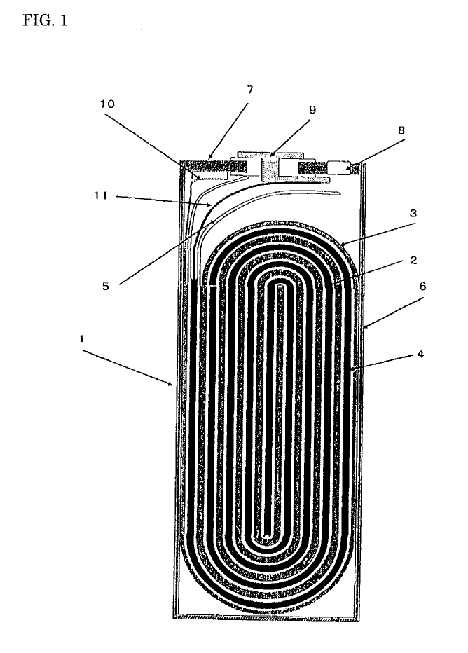

FIG. 1 is a longitudinal sectional view of the prismatic non-aqueous electrolyte secondary battery. In FIG. 1, the reference numeral 1 indicates a prismatic non-aqueous electrolyte secondary battery, the reference numeral 2 indicates a spirally coiled electrode block, the reference numeral 3 indicates a positive electrode, the reference numeral 4 indicates a negative electrode, the reference numeral 5 indicates a separator, the reference numeral 6 indicates a battery case, the reference numeral 7 indicates a battery cover, the reference numeral 8 indicates a safety valve, the reference numeral 9 indicates a negative electrode terminal, the reference numeral 10 indicates a positive electrode lead wire, and the reference numeral 11 indicates a negative electrode lead wire.

This prismatic non-aqueous electrolyte secondary battery 1 comprises the positive electrode 3 wherein a positive electrode compound is applied on an aluminum current collector, the negative electrode 4 wherein a negative electrode compound is applied on a copper current collector, the separator 5, the spirally coiled electrode block 2 wherein the positive and negative electrodes are wound with the separator therebetween, and the battery case 6 wherein a non-aqueous electrolyte and the spirally coiled electrode block are housed, having a size of 30 mm in width, 48 in height and 5 mm in thickness.

The battery cover 7 equipped with the safety valve 8 is laser-welded to the battery case 6. The negative electrode terminal 9 is connected to the negative electrode 4 through the negative electrode lead 11, and the positive electrode 3 is connected to the battery cover 7 via the positive electrode lead 10.

The positive electrode was prepared by a process which comprises mixing 8 wt % of polyvinylidene difluoride as a binder, 5 wt % of acetylene black as an electrically conducting material and 87 wt % of lithium-cobalt composite oxide as an active material to form a positive electrode compound, dispersing the positive electrode compound in N-methyl-2-pyrrolidone to prepare a paste, uniformly applying the positive electrode paste to the both sides of an aluminum foil current collector having a thickness of 20 μm, and drying the coated aluminum foil current collector.

The negative electrode was prepared by a process which comprises mixing 95 wt % of graphite, 2 wt % of carboxymethylcellulose and 3 wt % of styrene-butadiene rubber, adding an appropriate amount of water to the compound to prepare a paste, uniformly applying the paste to the both sides of a copper foil current collector having a thickness of 15 μm, and drying the coated copper foil current collector.

A microporous polyethylene film was used as the separator. As the non-aqueous electrolyte, 1.5 mol/l of LiBF₄ (lithium tetrafluoroborate) was dissolved in the gamma-butyrolactone (abbreviated to GBL in Table) which was used as a main solvent and then, based on the total weight of the non-aqueous electrolyte, 3 wt % of di-normal-butyl carbonate (abbreviated to DNBC in Table), which is a kind of the chain carbonic ester represented by formula 1, was added. A non-aqueous electrolyte secondary battery of Example 1 was prepared according to the above mentioned formulations and processes.

### Examples 2 to 28 and Comparative Examples 1 to 6

Non-aqueous electrolyte secondary batteries of Examples 2 to 28 and Comparative Examples 1 to 6 were prepared in the same manner as in Example 1 except that the main solvent for non-aqueous electrolyte comprised additionally ethylene carbonate (abbreviated to EC in Table) and methyl ethyl carbonate (abbreviated to MEC in Table) and comprised di-normal-butyl carbonate in a varied proportion and a chain carbonic ester of a different kind as set forth in Table 1. As the electrolyte salt, 1.5 mol/l of LiBF₄ was dissolved and used in every case. The main solvent represented here is equivalent to “a non-aqueous solvent except said chain carbonic ester” as set forth in Claims. In the case of comparative examples, some of the chain carbonic esters above mentioned are not equivalent to “a chain carbonic ester represented by formula 1” as set forth in Claims; however, for the sake of comparison with this invention and for convenience, they are described as the ones other than the main solvent which is equivalent to “a non-aqueous solvent except said chain carbonic ester.”

In the prismatic non-aqueous electrolyte secondary batteries of the examples and comparative examples prepared in the same manner as above mentioned, the initial discharge capacity, the cell thickness after high temperature storage, and the discharge capacity at 0° C. were examined. The initial discharge capacity indicates the discharge capacity obtained when the batteries were charged with a constant current of 600 mA to 4.2 V, then charged at a constant voltage of 4.2 V for 2.5 hours and then discharged with a current of 600 mA at an end-point voltage of 2.75 V. Regarding the batteries of Comparative Examples 1 to 5 wherein performing the first charge was extremely difficult so that the discharge capacity could not be obtained, the subsequent tests were canceled.

The measurements of the cell thickness after high temperature storage were taken in such a way that the batteries in which the examination of the initial discharge capacity was completed were charged with a constant current of 600 mA to 4.2 V, then charged at a constant voltage of 4.2 V for 2.5 hours, allowed to stand at a temperature of 80° C. for 100 hours, cooled down to a room temperature, and measured for the cell thickness.

The measurements of the discharge capacity at 0° C. were taken in such a way that the batteries in which the examination of the initial discharge capacity was completed were charged with a constant current of 600 mA to 4.2 V, then charged at a constant voltage of 4.2 V at 25° C. for 2.5 hours, allowed to stand at a temperature of 0° C. for 10 hours, discharged with a current of 600 mA at an end-point voltage of 2.75 V, and measured for the discharge capacity.

The formulations of the electrolytes used in the batteries of Examples 1 to 28 are set forth in Table 1, those of Comparative Examples 1 to 6 are set forth in Table 2, the results of the measurements of the performance of the batteries of Examples 1 to 28 are set forth in Table 3, and those of Comparative Examples 1 to 6 are set forth in Table 4.

Furthermore, the following solvents are abbreviated to the notation in parentheses in Table 1: methyl normal-butyl carbonate (MNBC), ethyl normal-butyl carbonate (ENBC), methyl normal-octyl carbonate (MNOC), methyl normal-hexyl carbonate (MNHXC), propyl normal-butyl carbonate (PNBC), di-normal-octyl carbonate (DNOC), di-normal-nonyl carbonate (DNNC), di-normal-decile carbonate (DNDC), and di-normal-dodecyl carbonate (DNDDC); and in Table 2: di-normal-propyl carbonate (DNPC), diethyl carbonate (DEC), and dimethyl carbonate (DMC).

TABLE 1

| | | | | Chain Carbonic Ester | | | |
|---|---|---|---|---|---|---|---|
| | Non-aqueous | | | | Number | Number | |
| | Solvent/vol % | | | Com- | of C in | of C in | Amount/ |
| | EC | GBL | MEC | pound | R1 | R2 | wt % |
| Example 1 | 0 | 100 | 0 | DNBC | 4 | 4 | 3 |
| Example 2 | 10 | 90 | 0 | DNBC | 4 | 4 | 1 |
| Example 3 | 20 | 80 | 0 | DNBC | 4 | 4 | 1 |
| Example 4 | 30 | 70 | 0 | DNBC | 4 | 4 | 1 |
| Example 5 | 40 | 60 | 0 | DNBC | 4 | 4 | 1 |
| Example 6 | 50 | 50 | 0 | DNBC | 4 | 4 | 1 |
| Example 7 | 60 | 40 | 0 | DNBC | 4 | 4 | 1 |
| Example 8 | 70 | 30 | 0 | DNBC | 4 | 4 | 1 |
| Example 9 | 27 | 63 | 10 | DNBC | 4 | 4 | 1 |
| Example | 24 | 56 | 20 | DNBC | 4 | 4 | 1 |
| 10 | | | | | | | |
| Example | 30 | 60 | 10 | DNBC | 4 | 4 | 0.5 |
| 11 | | | | | | | |
| Example | 30 | 60 | 10 | DNBC | 4 | 4 | 1 |
| 12 | | | | | | | |
| Example | 30 | 60 | 10 | DNBC | 4 | 4 | 3 |
| 13 | | | | | | | |
| Example | 30 | 60 | 10 | DNBC | 4 | 4 | 5 |
| 14 | | | | | | | |
| Example | 30 | 60 | 10 | DNBC | 4 | 4 | 10 |
| 15 | | | | | | | |
| Example | 30 | 60 | 10 | DNBC | 4 | 4 | 20 |
| 16 | | | | | | | |
| Example | 30 | 60 | 10 | MNBC | 4 | 1 | 3 |
| 17 | | | | | | | |
| Example | 30 | 60 | 10 | ENBC | 4 | 2 | 3 |
| 18 | | | | | | | |
| Example | 30 | 60 | 10 | MNHXC | 6 | 1 | 3 |
| 19 | | | | | | | |
| Example | 30 | 60 | 10 | MNOC | 8 | 1 | 3 |
| 20 | | | | | | | |
| Example | 30 | 60 | 10 | PNBC | 4 | 3 | 3 |
| 21 | | | | | | | |
| Example | 30 | 60 | 10 | DNOC | 8 | 8 | 3 |
| 22 | | | | | | | |
| Example | 30 | 60 | 10 | PNBC | 4 | 3 | 3 |
| 23 | | | | | | | |
| Example | 30 | 60 | 10 | DNHXC | 6 | 6 | 3 |
| 24 | | | | | | | |
| Example | 30 | 60 | 10 | DNOC | 8 | 8 | 3 |
| 25 | | | | | | | |
| Example | 30 | 60 | 10 | DNNC | 9 | 9 | 3 |
| 26 | | | | | | | |
| Example | 30 | 60 | 10 | DNDC | 10 | 10 | 3 |
| 27 | | | | | | | |
| Example | 30 | 60 | 10 | DNDDC | 12 | 12 | 3 |
| 28 | | | | | | | |

TABLE 2

| | | | | Chain Carbonic Ester | | | |
|---|---|---|---|---|---|---|---|
| | Non-aqueous | | | | Number | Number | |
| | Solvent/vol % | | | Com- | of C in | of C in | Amount/ |
| | EC | GBL | MEC | pound | R1 | R2 | wt % |
| Comparative | 30 | 70 | 0 | — | — | — | 0 |
| Example 1 | | | | | | | |
| Comparative | 30 | 70 | 0 | DMC | 1 | 1 | 5 |
| Example 2 | | | | | | | |
| Comparative | 30 | 70 | 0 | MEC | 2 | 1 | 5 |
| Example 3 | | | | | | | |
| Comparative | 30 | 70 | 0 | DEC | 2 | 2 | 5 |
| Example 4 | | | | | | | |
| Comparative | 30 | 70 | 0 | DNPC | 3 | 3 | 5 |
| Example 5 | | | | | | | |
| Comparative | 21 | 49 | 30 | DNBC | 4 | 4 | 5 |
| Example 6 | | | | | | | |

TABLE 3

| | Initial | | |
|---|---|---|---|
| | Discharge | Cell Thickness after | Discharge Capacity |
| | Capacity/mAh | Discharge/mm | at O° C./mAh |
| Example 1 | 588 | 5.1 | 465 |
| Example 2 | 593 | 5.1 | 486 |
| Example 3 | 593 | 5.1 | 492 |
| Example 4 | 595 | 5.2 | 515 |
| Example 5 | 591 | 5.3 | 496 |
| Example 6 | 589 | 5.4 | 489 |
| Example 7 | 592 | 5.4 | 397 |
| Example 8 | 593 | 5.4 | 320 |
| Example 9 | 592 | 5.8 | 539 |
| Example 10 | 593 | 5.9 | 557 |
| Example 11 | 590 | 5.2 | 503 |
| Example 12 | 592 | 5.3 | 503 |
| Example 13 | 594 | 5.3 | 504 |
| Example 14 | 592 | 5.2 | 503 |
| Example 15 | 591 | 5.1 | 384 |
| Example 16 | 573 | 5.2 | 360 |
| Example 17 | 590 | 5.3 | 509 |
| Example 18 | 593 | 5.2 | 501 |
| Example 19 | 591 | 5.3 | 503 |
| Example 20 | 594 | 5.3 | 506 |
| Example 21 | 592 | 5.2 | 506 |
| Example 22 | 593 | 5.1 | 480 |
| Example 23 | 592 | 5.1 | 474 |
| Example 24 | 591 | 5.2 | 476 |
| Example 25 | 593 | 5.1 | 480 |
| Example 26 | 592 | 5.1 | 474 |
| Example 27 | 593 | 5.2 | 471 |
| Example 28 | 592 | 5.1 | 466 |

TABLE 4

| | Initial | | |
|---|---|---|---|
| | Discharge | Cell Thickness after | Discharge Capacity |
| | Capacity/mAh | Discharge/mm | at O° C./mAh |
| Comparative | 0 | — | — |
| Example 1 | | | |
| Comparative | 0 | — | — |
| Example 2 | | | |
| Comparative | 0 | — | — |
| Example 3 | | | |
| Comparative | 0 | — | — |
| Example 4 | | | |
| Comparative | 0 | — | — |
| Example 5 | | | |
| Comparative | 598 | 8.3 | 568 |
| Example 6 | | | |

As can be seen in the results set forth in Tables 1 to 4, in the batteries of Comparative Example 1 wherein the di-normal-butyl carbonate (DNBC) is not contained and those of Comparative Examples 2 to 5 wherein the chain carbonic ester represented by formula 1 has the carbon number in R 1 less than 4, performing charging and discharging was extremely difficult so that a prescribed discharge capacity could not be obtained. The batteries of the Comparative Examples 2 to 5 wherein the discharge capacity could not be obtained were disassembled after examination, and then it was found that the non-aqueous electrolyte did not permeate the separator at all and that the permeability of the non-aqueous electrolyte through the electrodes was insufficient, too.

On the other hand, in the batteries of Examples 1 to 28 and Comparative Example 6 wherein the non-aqueous electrolyte comprised the chain carbonic ester represented by formula 1 having the carbon number in R 1 is 4 or more , regardless of what solvent composition was comprised or what type of the compound in formula 1 was used, it was possible to perform charging and discharging. It is believed that since the chain carbonic ester represented by formula 1 holds a surface active property, the wettability of the non-aqueous electrolyte in the electrode plates or the separator increased and accordingly the interface resistance between the electrodes and the non-aqueous electrolyte was reduced.

The batteries of Comparative Examples 1 to 28 wherein the sum of volume ratios of ethylene carbonate (EC) and gamma-butyrolactone (GBL) is 80% or more exhibited the cell thickness as small as 5.9 mm, at most, even when left at 80° C. for 50 hours. The battery of Comparative Example 6 wherein the sum of volume ratios thereof is less than 80% exhibited the cell thickness as large as 8.3 mm when left at 80° C. for 100 hours. It is believed that this is because when the sum of volume ratios of EC and GBL having high boiling points and low vapor pressures becomes less than 80%, the vapor pressure of the non-aqueous electrolyte may become low or gas may be generated due to the reaction between the electrodes and the non-aqueous solvents other than EC or GBL.

Therefore, in order to inhibit bulging at high temperature storage, a preferable range of the sum of volume ratios of EC and GBL in the main solvent was found to be 80% or more.

In addition, in the batteries of Examples 1 to 8 wherein the volume ratios between EC and GBL are different, when the volume ratio of GBL was 50% or more, the discharge capacity at 0° C. was likely to increase. As the reason for this, it is considered that since the viscosity of GBL at low temperatures is lower compared to that of EC, the lithium ion conductivity at low temperatures became high. Thus, in order to provide the batteries having a small bulge at high temperature storage and a large capacity at low-temperature discharge, a preferable volume ratio of GBL in the main solvent was found to be 50% or more.

Furthermore, the battery of Example 13 and, with respect to the batteries of Comparative Examples 17 to 28, the batteries wherein the non-aqueous electrolyte contained the two hydrocarbon groups in a chain carbonic ester represented by formula 1 in equal portions, as is the case with Example 13 wherein the non-aqueous electrolyte contained DNBC, exhibited improved wettability of the non-aqueous electrolyte and the battery components and a remarkably increased initial discharge capacity. In addition, the batteries of Examples 13, 17, 18, 19 and 20 wherein di-normal-butyl carbonate (DNBC), methyl normal-butyl carbonate (MNBC), ethyl normal-butyl carbonate (ENBC), methyl normal-hexyl carbonate (MNHXC) and methyl normal-octyl carbonate (MNOC) were examined exhibited a larger discharge capacity at 0° C. than the batteries of other examples wherein other chain carbonic esters were used.

The reason is not clear but it is a likely assumption that DNBC, MNBC, ENBC, MHNXC and MNOC exhibit no significant increase in the viscosity of the non-aqueous electrolyte at low temperatures, or form a surface film with low resistance on the negative electrode, compared to other chain carbonic esters represented by formula 1. Therefore, as a chain carbonic ester represented by formula 1, di-normal-butyl carbonate (DNBC), methyl normal-butyl carbonate (MNBC), ethyl normal-butyl carbonate (ENBC), methyl normal-hexyl carbonate (MNHXC) and methyl normal-octyl carbonate (MNOC) were found to be more preferable.

Further, the batteries of Comparative Example 1 wherein the content of DNBC was varied in the range of 0 to 20 wt %, those of Comparative Example 4, and those of Examples 11 to 16 were examined for the non-aqueous electrolyte. As a result, the batteries wherein the weight ratio of DNBC is 0.5% or more were found to exhibit improved wettability of the non-aqueous electrolyte in the electrodes and the separator. In addition, when the weight ratio of DNBC is more than 5.0%, it was found that low-temperature discharge performance was likely to be deteriorated. This is probably due to the effect of an increase in the viscosity of the non-aqueous electrolyte or an increase in the resistance of negative electrode surface film. Therefore, for improving both wettability and low-temperature discharge performance, the preferable weight ratio of DNBC was found to be not less than 0.5% and not more than 5.0%.

### Examples 29 to 34

Non-aqueous electrolyte secondary batteries of Examples 29 to 34 were prepared in the same manner as in Example 1 except that a mixed solvent of EC and GBL, 30 vol % and 70 vol %, respectively, was used as a main solvent, 1.5 mol/l of LiBF₄ was dissolved in this solvent, and the electrolyte solution thus prepared contained 3 wt % of DNBC and 1 wt % of the following, respectively: vinylene carbonate, vinyl ethylene carbonate, 1,3-propane sultone, 1,3-propene sultone(propane-1-ene-1,3-sultone), ethylene glycol cyclic sulfate and divinylsulfone.

In the prismatic non-aqueous electrolyte secondary batteries of Examples 29 to 34, the initial discharge capacity, the cell thickness after high temperature storage, and the discharge capacity at 0° C. were examined. The initial discharge capacity indicates the discharge capacity obtained when the batteries were charged with a constant current of 600 mA to 4.2 V, then charged at a constant voltage of 4.2 V for 2.5 hours and then discharged with a current of 600 mA at an end-point voltage of 2.75 V.

The measurements of the cell thickness after high temperature storage were taken in such a way that the batteries wherein the examination of the initial discharge capacity was completed were charged with a constant current of 600 mA to 4.2 V, then charged at a constant voltage of 4.2 V for 2.5 hours, allowed to stand at a temperature of 80° C. for 100 hours, cooled down to a room temperature, and measured for the cell thickness.

The measurements of the discharge capacity at 0° C. were taken in such a way that the batteries wherein the examination of the initial discharge capacity was completed were charged with a constant current of 600 mA to 4.2 V, then charged at a constant voltage of 4.2 V at 25° C. for 2.5 hours, allowed to stand at a temperature of 0° C. for 10 hours, discharged with a current of 600 mA at an end-point voltage of 2.75 V, and measured for the discharge capacity.

The formulations of the electrolytes used in the batteries of Examples 29 to 34 and the results of the measurements of the performance thereof are set forth in Table 5.

TABLE 5

| | | Initial | | Discharge |
|---|---|---|---|---|
| | Compound other than | Discharge | Cell Thickness | Capacity |
| | DNBC | Capacity/mAh | after Discharge/mm | at O° C./mAh |
| Example 29 | vinylene carbonate | 604 | 5.1 | 556 |
| Example 30 | Vinyl ethylene carbonate | 600 | 5.1 | 536 |
| Example 31 | 1,3-propane sultone | 602 | 5.1 | 512 |
| Example 32 | 1,3-propene sultone | 603 | 5.1 | 511 |
| | (propane-1-ene-1,3-sultone) | | | |
| Example 33 | ethylene glycol cyclic | 600 | 5.1 | 560 |
| | sulfate | | | |
| Example 34 | divinylsulfone | 601 | 5.1 | 532 |

The batteries of Examples 29 to 34 wherein the non-aqueous electrolyte contains such compounds as vinylene carbonate, vinyl ethylene carbonate, 1,3-propane sultone, 1,3-propene sultone(propane-1-ene-1,3-sultone), ethylene glycol cyclic sulfate and divinylsulfone exhibited an greater initial discharge capacity at 25° C. than the batteries of Example 4 wherein the non-aqueous electrolyte does not contain such compounds. This was probably because said compounds formed a stable reducing surface film on the negative electrode and then inhibited the formation of a high resistant surface film on the negative electrode which was due to the reduction decomposition of DNBC. These compounds work satisfactorily in the non-aqueous electrolyte. According to the type of an electrode or the composition of a solvent, it is possible to use only one of these compounds or mixture thereof.

### Examples 35 to 44 and Comparative Examples 7 to 9

Non-aqueous electrolyte secondary batteries of Examples 35 to 44 and Comparative Examples 7 to 9 were prepared in the same manner as in Example 1 except that a mixed solvent of ethylene carbonate (EC), propylene carbonate (PC) and methyl ethyl carbonate (MEC) was used as a main solvent, 1.5 M of LiPF₆ as an electrolyte salt was dissolved in this mixed solvent to prepare an electrolyte solution, 1 wt % of vinylene carbonate was added based on the total weight of this electrolyte solution, and a chain carbonic ester in varied proportions and different types was used. With respect to the chain carbonic ester, di-normal-octyl carbonate (DNOC) was added in Example 43, di-normal-propyl carbonate (DNPC) in Comparative Example 8, and di-normal-butyl carbonate (DNBC) in the rest of the examples.

In the prismatic non-aqueous electrolyte secondary batteries of Examples 35 to 44 and Comparative Examples 7 to 9 prepared in the same manner as above mentioned, the initial discharge capacity, the cell thickness after high temperature storage, and the discharge capacity at 0° C. were examined.

The initial discharge capacity indicates the discharge capacity obtained when the batteries were charged with a constant current of 600 mA to 4.2 V, then charged at a constant voltage of 4.2 V for 2.5 hours and then discharged with a current of 600 mA at an end-point voltage of 2.75 V. Regarding the batteries of Comparative Examples 7 and 8 wherein performing the first charge was extremely difficult so that the discharge capacity could not be obtained, the subsequent tests were canceled.

The measurements of the cell thickness after high temperature storage were taken in such a way that the batteries wherein the examination of the initial discharge capacity was completed were charged with a constant current of 600 mA to 4.2 V, then charged at a constant voltage of 4.2 V for 2.5 hours, allowed to stand at a temperature of 80° C. for 100 hours, cooled down to a room temperature, and measured for the cell thickness.

The measurements of the discharge capacity at 0° C. were taken in such a way that the batteries wherein the examination of the initial discharge capacity was completed were charged with a constant current of 600 mA to 4.2 V, then charged at a constant voltage of 4.2 V at 25° C. for 2.5 hours, allowed to stand at a temperature of 0° C. for 10 hours, discharged with a current of 600 mA at an end-point voltage of 2.75 V, and measured for the discharge capacity.

The formulations of the electrolytes used in the batteries of Examples 35 to 44 and Comparative Examples 7 to 9 are set forth in Table 6, and the results of the measurements of the performance thereof are set forth in Table 7.

TABLE 6

| | Non-aqueous | | | Chain Carbonic Ester | | | |
|---|---|---|---|---|---|---|---|
| | Solvent/vol % | | | | Number | Number | Amount/ |
| | EC | PC | MEC | Compound | of C in R1 | of C in R2 | wt % |
| Example 35 | 0 | 100 | 0 | DNBC | 4 | 4 | 3 |
| Example 36 | 30 | 70 | 0 | DNBC | 4 | 4 | 3 |
| Example 37 | 50 | 50 | 0 | DNBC | 4 | 4 | 3 |
| Example 38 | 60 | 40 | 0 | DNBC | 4 | 4 | 3 |
| Example 39 | 30 | 70 | 0 | DNBC | 4 | 4 | 0.5 |
| Example 40 | 30 | 70 | 0 | DNBC | 4 | 4 | 5 |
| Example 41 | 30 | 70 | 0 | DNBC | 4 | 4 | 10 |
| Example 42 | 24 | 56 | 20 | DNBC | 4 | 4 | 3 |
| Example 43 | 30 | 70 | 0 | DNOC | 8 | 8 | 3 |
| Example 44 | 30 | 70 | 0 | DNDDC | 12 | 12 | 3 |
| Comparative Example 7 | 30 | 70 | 0 | — | — | — | 0 |
| Comparative Example 8 | 30 | 70 | 10 | DMPC | 3 | 3 | 3 |
| Comparative Example 9 | 21 | 49 | 30 | DNBC | 3 | 3 | 3 |

TABLE 7

| | Initial | | |
|---|---|---|---|
| | Discharge | Cell Thickness after | Discharge Capacity |
| | Capacity/mAh | Discharge/mm | at O° C./mAh |
| Example 35 | 592 | 5.5 | 434 |
| Example 36 | 602 | 5.2 | 425 |
| Example 37 | 603 | 5.4 | 380 |
| Example 38 | 601 | 5.3 | 150 |
| Example 39 | 589 | 5.4 | 410 |
| Example 40 | 600 | 5.4 | 420 |
| Example 41 | 598 | 5.6 | 370 |
| Example 42 | 602 | 5.5 | 450 |
| Example 43 | 603 | 5.4 | 397 |
| Example 44 | 603 | 5.3 | 395 |
| Comparative | 0 | — | — |
| Example 7 | | | |
| Comparative | 0 | — | — |
| Example 8 | | | |
| Comparative | 598 | 9.3 | 480 |
| Example 9 | | | |

As can be seen in the results set forth in Tables 6 to 7, in the batteries of Comparative Example 7 wherein the chain carbonate represented by formula 1 is not contained and those of Comparative Example 8 wherein di-normal-propyl carbonate (DNPC) has the carbon number in R 1 less than 4, performing charging and discharging was extremely difficult so that a prescribed discharge capacity could not be obtained. On the other hand, in the batteries of Examples 35 to 44 and Comparative Example 9 wherein the di-normal-butyl carbonate (DNBC) and di-normal-octyl carbonate (DNOC) having the carbon number in R is 4 or more and di-normal-dodecyl carbonate (DNDDC) were added, it was possible to perform charging and discharging. The batteries of the Comparative Examples 7 and 8 wherein charging and discharging could not be performed were disassembled after examination, and then it was found that the non-aqueous electrolyte did not permeate the separator at all and that the permeability of the non-aqueous electrolyte through the electrodes was insufficient, too.

The batteries of Examples 35 to 44 wherein the sum of volume ratios of ethylene carbonate (EC) and propylene carbonate (PC) is 80% or more exhibited the cell thickness as small as 5.6 mm, at most, even when left at 80° C. for 100 hours. The battery of Comparative Example 9 wherein the sum of volume ratios thereof is less than 80% exhibited the cell thickness as much large as 9.3 mm when left at 80° C. for 100 hours. It is believed that this is because when the sum of volume ratios of EC and PC having high-boiling-points and low-vapor-pressures becomes less than 80%, the vapor pressure of the non-aqueous electrolyte may become low or gas may be generated due to the reaction between the electrodes and the non-aqueous solvents other than EC or PC.

Therefore, in order to inhibit bulging at high temperature storage, a preferable range of the sum of volume ratios of EC and GBL in the main solvent was found to be 80% or more.

In addition, in the batteries of Examples 35 to 39 wherein the volume ratios between EC and PC are different, when the volume ratio of PC was 50% or more, the discharge capacity at 0° C. was likely to increase. As the reason for this, it is considered that since the viscosity of PC at low temperatures is lower compared to that of EC, the lithium ion conductivity at low temperatures became high. Thus, in order to provide the batteries having a small bulge at high temperature storage and a large discharge capacity at low-temperature, a preferable volume ratio of PC in the main solvent was found to be 50% or more.

Furthermore, with respect to the batteries of Examples 35, 43 and 44, the battery of Example 35 wherein the non-aqueous electrolyte contains 3 wt % of di-normal-butyl carbonate (DNBC) exhibited a larger discharge capacity than that of Example 38 wherein the non-aqueous electrolyte contains 3 wt % of di-normal-octyl carbonate (DNOC) and di-normal-dodecyl carbonate (DNDDC).

The reason is not clear but it is a likely assumption that DNBC exhibits no significant increase in the viscosity of the non-aqueous electrolyte at low temperatures, or forms a negative electrode surface film with low resistance on the negative electrode, compared to other chain carbonic esters. Therefore, as a chain carbonic ester represented by formula 1, DNBC was found to be more preferable.

Further, the batteries of Comparative Example 7 and Examples 35, 39 to 41 wherein the content of DNBC was varied in the range of 0 to 10 wt % were examined for the non-aqueous electrolyte. As a result, the batteries wherein the weight ratio of DNBC is 0.5% or more were found to exhibit improved wettability of the non-aqueous electrolyte in the electrodes and the separator. In addition, when the weight ratio of DNBC is more than 5.0%, it was found that low-temperature discharge performance was likely to be deteriorated. This is probably due to the effect of an increase in the viscosity of the non-aqueous electrolyte or an increase in the resistance of negative electrode surface film. Therefore, for improving both wettability and low-temperature discharge performance, the preferable weight ratio of DNBC was found to be not less than 0.5% and not more than 5.0%.

### Examples 45 to 50

Non-aqueous electrolyte secondary batteries of Examples 45 to 50 were prepared in the same manner as in Example 1 except that a mixed solvent of EC and GBL, 30 vol % and 70 vol %, respectively, was used as a main solvent, 1.5 mol/l of LiBF₄ was dissolved in this solvent, and the electrolyte solution thus prepared contained 3 wt % of a partly-fluorinated chain carbonate wherein fluorine atoms were partly substituted for hydrogen atoms, an alkyl group, as shown in Table 8.

TABLE 8

| | | Number of | Number of | |
|---|---|---|---|---|
| | R1 | C in R1 | R2 | C in R2 |
| Example 45 | CH3(CH2)3— | 4 | CF3— | 1 |
| Example 46 | CH3(CH2)3— | 4 | CF3CH2— | 2 |
| Example 47 | CH3(CH2)3— | 4 | CF3(CH2)2— | 3 |
| Example 48 | CH3(CH2)3— | 4 | CF3(CH2)3— | 4 |
| Example 49 | CH3(CH2)7— | 8 | CF3CH2— | 2 |
| Example 50 | CH3(CH2)11— | 12 | CF3CH2— | 2 |

In the prismatic non-aqueous electrolyte secondary batteries of Examples 45 to 50, the initial discharge capacity, the cell thickness after high temperature storage, and the discharge capacity at 0° C. were examined. The initial discharge capacity indicates the discharge capacity obtained when the batteries were charged with a constant current of 600 mA to 4.2 V, then charged at a constant voltage of 4.2 V for 2.5 hours and then discharged with a current of 600 mA at an end-point voltage of 2.75 V.

The measurements of the cell thickness after high temperature storage were taken in such a way that the batteries wherein the examination of the initial discharge capacity was completed were charged with a constant current of 600 mA to 4.2 V, then charged at a constant voltage of 4.2 V for 2.5 hours, allowed to stand at a temperature of 80° C. for 100 hours, cooled down to a room temperature, and measured for the cell thickness.

The measurements of the discharge capacity at 0° C. were taken in such a way that the batteries wherein the examination of the initial discharge capacity was completed were charged with a constant current of 600 mA to 4.2 V, then charged at a constant voltage of 4.2 V at 25° C. for 2.5 hours, allowed to stand at a temperature of 0° C. for 10 hours, discharged with a current of 600 mA at an end-point voltage of 2.75 V, and measured for the discharge capacity.

The formulations of the electrolytes used in the batteries of Examples 45 to 50 and the results of the measurements of the performance thereof are set forth in Table 9.

TABLE 9

| | Initial | | |
|---|---|---|---|
| | Discharge | Cell Thickness after | Discharge Capacity |
| | Capacity/mAh | Discharge/mm | at O° C./mAh |
| Example 45 | 592 | 5.2 | 538 |
| Example 46 | 598 | 5.3 | 543 |
| Example 47 | 593 | 5.2 | 534 |
| Example 48 | 595 | 5.2 | 536 |
| Example 49 | 596 | 5.3 | 529 |
| Example 50 | 597 | 5.3 | 496 |

As can be seen in the results set forth in Table 9, in the case where fluorine atoms were partly substituted for hydrogen atoms in a chain carbonate represented by formula 1, improved wettability was obtained and the charging and discharging of the batteries was possible.

In addition, the batteries of Example 45 wherein the fluorinated chain carbonate represented by formula 1 was used was found to exhibit improved low-temperature discharge performance compared to the batteries of Example 4 wherein non-fluorinated chain carbonate represented by formula 1 was used.

The reason is not clear but it is considered that when the fluorinated chain carbonate was used, a negative electrode surface film with low interface resistance was more likely to be formed during the first charge compared to when the non-fluorinated chain carbonate was used.

As stated above, in the non-aqueous electrolyte secondary batteries wherein ethylene carbonate and gamma-butyrolactone, and propylene carbonate were used as a non-aqueous solvent for the electrolyte, and a chain carbonic ester represented by formula 1 was added to this solvent, wettability of the electrolyte in the electrodes and the separator was improved. In addition, when part of the hydrogen in a chain carbonic ester represented by formula 1 was substituted by halogen, low-temperature discharge performance was found to be improved.

As the electrolyte salt, 1.5 M of LiBF₄ or LiPF₆ was dissolved in the electrolyte solvent and used in these examples. However, regardless of the type or the concentration of the electrolyte salt, improved wettability of the electrolyte solution in the electrodes and the separator can be obtained.

In accordance with the invention, R1 in a chain carbonic ester represented by formula 1 is a hydrocarbon group with carbon number varied from 4 to 12. It is not specifically limited so that any straight-chain or branched saturated or unsaturated hydrocarbon group can be used. Examples of aliphatic hydrocarbon groups employable herein include n-butyl group, isobutyl group, sec-butyl group, t-butyl group, 1-butenyl group, 2-butenyl group, 3-butenyl group, 2-methyl-2-propenyl group, 1-methylen propyl group, 1-methyl-2-propenyl group, 1,2-dimethyl vinyl group, 1-butynyl group, 2-butynyl group, 3-butynyl group, pentyl group, 1-methyl butyl group, 1-methyl-2-methyl propyl group, hexyl group, octyl group, nonyl group, and decyl group.

In addition, R2 is a hydrocarbon group with carbon number varied from 1 to 12. It is not specifically limited so that any straight-chain or branched saturated or unsaturated hydrocarbon group can be used. Examples of aliphatic hydrocarbon groups employable herein include methyl group, ethyl group, n-propyl group, isopropyl group, n-butyl group, isobutyl group, sec-butyl group, t-butyl group, 1-butenyl group, 2-butenyl group, 3-butenyl group, 2-methyl-2-propenyl group, 1-methylen propyl group, 1-methyl-2-propenyl group, 1,2-dimethyl vinyl group, 1-butynyl group, 2-butynyl group, 3-butynyl group, pentyl group, 1-methyl butyl group, 1-methyl-2-methyl propyl group, hexyl group, octyl group, nonyl group, and decyl group.

Further, part or all of the hydrogen atoms of the R1 or R2 hydrocarbon group may be substituted by halogen.

These hydrocarbon groups have a surfactant effect, so that the wettability of the non-aqueous electrolyte in the electrodes and the separator can be improved. According to the type of battery materials or solvents, appropriate hydrocarbon groups can be selected.

The main solvent contains at least either propylene carbonate or gamma-butyrolactone at a concentration of 50 vol % or more. This allows the melting point of the non-aqueous electrolyte to decrease and accordingly the low-temperature discharge performance of the battery is improved.

The weight ratio of the chain carbonic ester to the total weight of the non-aqueous electrolyte is not less than 0.5% and not more than 5%. This allows the viscosity of the non-aqueous electrolyte solution to decrease, so that the batteries which are excellent in low-temperature discharge performance can be provided.

As the chain carbonic ester represented by formula 1, it is highly preferable to use di-normal-butyl carbonate, methyl normal-butyl carbonate, ethyl normal-butyl carbonate, methylhexyl carbonate, or methyl normal-octyl carbonate. The use of these carbonates is advantageous in that they can not only inhibit an increase in the viscosity of the non-aqueous electrolyte at low temperatures but also improve the wettability, so that the batteries which are excellent in charge and discharge performance can be provided.

As the non-aqueous electrolyte, either an electrolyte solution or a solid electrolyte can be used. As a solvent for the electrolyte solution, there may be used a main solvent comprising at least one of the group of such components as ethylene carbonate, propylene carbonate or gamma-butyrolactone, or a mixture of the non-aqueous solvents other than a chain carbonic ester. Examples of the non-aqueous solvents employable herein include such polar solvents as dimethyl carbonate, ethyl methyl carbonate, diethyl carbonate, sulfolane, dimethyl sulfoxide, acetonitrile, dimethyl formamide, dimethyl acetamide, 1,2-dimethoxyethane, 1,2-diethoxyethane, tetrahydrofuran, 2-methyl tetrahydrofuran, dioxolane, methyl acetate, etc., or mixture thereof.

In addition, it is more preferable that the non-aqueous electrolyte contains at least one of the following; vinylene carbonate, vinylethylene carbonate, 1,3-propane sultone, 1,3-propene sultone(propane-1-ene-1,3-sultone), ethylene glycol cyclic sulfate or divinyl sulfone, because an initial discharge capacity and a low-temperature discharge capacity increase. It is possible to use only one of these compounds including vinylene carbonate, vinylethylene carbonate, 1,3-propane sultone, 1,3-propene sultone(propane-1-ene-1,3-sultone), ethylene glycol cyclic sulfate or divinyl sulfone, or mixture thereof. According to the type of battery materials or solvents, appropriate one can be selected.

As the lithium salt to be dissolved in the non-aqueous solvent, examples include LiPF₆, LiClO₄, LiBF₄, LiAsF₆, LiCF₃CO₂, LiCF₃(CF₃)₃, LiCF₃(C₂F₅)₃, LiCF₃SO₃, LiN(SO₂CF₃)₂, LiN(SO₂CF₂CF₃)₂, LiN(COCF₃)₂, LiN(COCF2CF₃)₂ and LiPF₃ (CF₂CF₃)₃, or mixture thereof.

Preferred among them is LiBF₄ because of its excellent heat stability at high temperatures. Particularly preferred is the mixture of LiBF₄ and the LiPF₆ having high conductivity.

With respect to the positive active material to be used, examples of positive active materials among inorganic compounds include composite oxides expressed by empirical formulae as LixMO₂, LixM₂O₄ and an empirical formula as NaₓMO₂ (in which M represents a transition metal of one or more kinds, 0≦x≦1, and 0≦y≦2), and metal-chalcogene compounds or metal oxides having tunnel structures or layered structures. More specifically, LiCoO₂, LiNiO₂, LiNi_{1/2}Mn_{1/2}O₂, LiNi_{1/3}Mn_{1/3}Co_{1/3}O₂, LiCoₓNi₁₋ₓO₂, LiMn₂O₄, Li₂Mn₂O₄, MnO₂, Fe₂, V₂₀₅, V₆O₁₃, TiO₂,TiS₂, etc. can be used.

And an example of positive active materials among organic compounds includes an electrically-conductive polymer such as polyaniline, etc. Further, the mixture of the above listed active materials, inorganic compounds or organic compounds, may be used.

As the negative active material to be used, on the other hand, examples include alloys of lithium and Al, Si, Pb, Sn, Zn, Cd, etc., metal oxides such as LiFe₂O₃, WO₂, MoO₂, SiO, SiO₂, CuO, etc., carbonaceous material such as graphite, carbon, etc., lithium nitride such as Li₅(Li₃N), etc. or lithium metal, or mixture thereof.

In the separator to be incorporated in the non-aqueous electrolyte battery according to the invention, a woven fabric, a nonwoven fabric, a microporous synthetic resin film, etc. may be used. Particularly preferred among these separator materials is microporous synthetic resin film. In particular, a microporous polyolefin film such as microporous polyethylene film, microporous polypropylene film and composite thereof is preferably used from the standpoint of thickness, strength, resistivity, etc.

A solid electrolyte such as solid polymer electrolyte can be a separator as well. With a solid polymer electrolyte containing the above mentioned electrolyte solution, the solid electrolyte functions as a separator. In this case, when a gel-like solid polymer electrolyte is used, the electrolyte solution constituting the gel may be different from the electrolyte solution to be incorporated in the pores. Alternatively, a microporous synthetic resin film may be used in combination with a solid polymer electrolyte, etc.

The shape of the battery is not specifically limited. The present invention can be applied to non-aqueous electrolyte secondary batteries in various forms such as prism, ellipse, coin, button and sheet. An object of the present invention is to inhibit bulging when the battery is left at high temperatures; therefore, in the case where the mechanical strength of a battery case is insufficient, particularly when an aluminum case or aluminum-laminated case is used, greater effects can be provided.

As clearly described in the above paragraphs, a non-aqueous electrolyte secondary battery comprises a non-aqueous electrolyte comprising a non-aqueous solvent and a lithium salt, a negative electrode, and a positive electrode. The sum of volume ratios of the ethylene carbonate, propylene carbonate and gamma-butyrolactone contained in the non-aqueous solvent is 80% or more and, in addition, the non-aqueous solvent contains a chain carbonic ester having a hydrocarbon group with carbon number varied from 4 to 12 and a hydrocarbon group with carbon number varied from 1 to 12. Such formulation of the non-aqueous solvent improved the wettability of the non-aqueous electrolyte in a separator and electrodes and, as a result, it was possible to improve battery performance and reduce bulging remarkably when the battery was left at high temperatures.

Thus, in a non-aqueous electrolyte secondary battery housed in a battery case such as the aluminum case or aluminum-laminated case which is thin and light and exhibits a high capacity and low resistance to pressure, the foregoing features are considered particularly effective techniques, and accordingly, the present invention has high industrial values.

While the invention has been described in detail and with reference to specific embodiments thereof, it will be apparent to one skilled in the art that various changes and modifications can be made therein without departing from the scope thereof.

This application is based on Japanese patent application No. 2002-25969 filed Feb. 1, 2002, the entire contents thereof being hereby incorporated by reference.

What is claimed is:

1. A non-aqueous electrolyte battery comprising a non-aqueous electrolyte which contains:
a chain carbonic ester represented by formula 1, 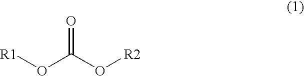
wherein R1 is a hydrocarbon group with carbon number varied from 4 to 12, and R2 is a hydrocarbon group with carbon number varied from 1 to 12;
a non-aqueous solvent except said chain carbonic ester, wherein said non-aqueous solvent contains ethylene carbonate, propylene carbonate or gamma-butyrolactone, and the sum of volume ratios of ethylene carbonate, propylene carbonate and gamma-butyrolactone in said non-aqueous solvent is 80% or more; and
a lithium salt.

2. The non-aqueous electrolyte secondary battery according to claim 1, wherein said non-aqueous solvent contains at least either propylene carbonate or gamma-butyrolactone at a concentration of 50 vol % or more.

3. The non-aqueous electrolyte secondary battery according to claim 1, wherein the weight ratio of said chain carbonic ester to the sum of said non-aqueous solvent and said lithium salt in said non-aqueous electrolyte is not less than 0.5% and not more than 5%.

4. The non-aqueous electrolyte secondary battery according to claim 1, wherein said chain carbonic ester contains di-normal-butyl carbonate, methylhexyl carbonate or methyloctyl carbonate.

5. The non-aqueous electrolyte secondary battery according to claim 1, wherein said non-aqueous solvent contains vinylene carbonate, vinylethylene carbonate, 1,3-propane sultone, 1,3-propene sultone(propane-1-ene-1,3-sultone), ethylene glycol cyclic sulfate or divinyl sulfone.

6. The non-aqueous electrolyte secondary battery according to claim 1, wherein part or all of the hydrogen of said R1 or said R2 is substituted by halogen.

7. The non-aqueous electrolyte secondary battery according to claim 1, wherein the volume ratio of ethylene carbonate in said non-aqueous solvent is not less than 0.1% and not more than 50%.

8. The non-aqueous electrolyte secondary battery according to claim 7, wherein said non-aqueous solvent contains at least either propylene carbonate or gamma-butyrolactone at a concentration of 50 vol % or more.

9. The non-aqueous electrolyte secondary battery according to claim 7, wherein the weight ratio of said chain carbonic ester to the sum of said non-aqueous solvent and said lithium salt in said non-aqueous electrolyte is not less than 0.5% and not more than 5%.

10. The non-aqueous electrolyte secondary battery according to claim 7, wherein said chain carbonic ester contains di-normal-butyl carbonate, methylhexyl carbonate or methyloctyl carbonate.

11. The non-aqueous electrolyte secondary battery according to claim 7, wherein said non-aqueous solvent contains vinylene carbonate, vinylethylene carbonate, 1,3-propane sultone, 1,3-propene sultone(propane-1-ene-1,3-sultone), ethylene glycol cyclic sulfate or divinyl sulfone.

12. The non-aqueous electrolyte secondary battery according to claim 7, wherein part or all of the hydrogen of said R1 or said R2 is substituted by halogen.

13. The non-aqueous electrolyte secondary battery according to claim 2, wherein said non-aqueous solvent contains at least either propylene carbonate or gamma-butyrolactone at a concentration of 80 vol % or more.

14. The non-aqueous electrolyte secondary battery according to claim 13, wherein the weight ratio of said chain carbonic ester to the sum of said non-aqueous solvent and said lithium salt in said non-aqueous electrolyte is not less than 0.5% and not more than 5%.

15. The non-aqueous electrolyte secondary battery according to claim 13, wherein said chain carbonic ester contains di-normal-butyl carbonate, methylhexyl carbonate or methyloctyl carbonate.

16. The non-aqueous electrolyte secondary battery according to claim 13, wherein said non-aqueous solvent contains vinylene carbonate, vinylethylene carbonate, 1,3-propane sultone, 1,3-propene sultone(propane-1-ene-1,3-sultone), ethylene glycol cyclic sulfate or divinyl sulfone.

17. The non-aqueous electrolyte secondary battery according to claim 13, wherein part or all of the hydrogen of said R1 or said R2 is substituted by halogen.
